(19) United States
(12) Patent Application Publication
(10) Pub. No.: US 2017/0295531 A1
(43) Pub. Date: Oct. 12, 2017

(54) DEVICE TO DEVICE MOBILITY MANAGEMENT METHOD, USER EQUIPMENT AND NETWORK ENTITY USING THE SAME

(71) Applicant: Industrial Technology Research Institute, Hsinchu (TW)

(72) Inventors: Shubhranshu Singh, Hsinchu City (TW); Hua-Lung Tsai, Taipei City (TW); Mei-Ju Shih, Taichung City (TW); Hung-Yu Wei, Taipei City (TW); Heng-Li Chin, Taipei City (TW)

(73) Assignee: Industrial Technology Research Institute, Hsinchu (TW)

(21) Appl. No.: 15/485,229

(22) Filed: Apr. 12, 2017

Related U.S. Application Data
(60) Provisional application No. 62/321,228, filed on Apr. 12, 2016.

(51) Int. Cl. H04W 36/30; H04W 40/24; H04W 8/08; H04W 76/02

(52) U.S. Cl. CPC H04W 36/30; H04W 76/023; H04W 40/246; H04W 8/08; H04W 40/248; H04W 88/04

(57) ABSTRACT

The disclosure is directed to a device to device (D2D) mobility management method applicable to a network entity and a user equipment and related apparatuses. In one of the exemplary embodiments, the disclosure is directed to a device to device (D2D) mobility management method used by a network entity. The method would include not limited to transmitting a service request message which includes an application identifier (ID) and a traffic type ID, receiving a first measurement report including a signal quality measurement which is measured based on the service request message, determining a topology type ID and a communication type ID in response to receiving the first measurement report, transmit an access request message which comprises the topology type ID, the communication type ID, and the traffic type ID, and receive an authorization of a network slice in response to transmitting the access request message.

### CROSS-REFERENCE TO RELATED APPLICATION

This application claims the priority benefits of U.S. provisional application Ser. No. 62/321,228, filed on Apr. 12, 2016. The entirety of the above-mentioned patent application is hereby incorporated by reference herein and made a part of this specification.

### TECHNICAL FIELD

The disclosure is directed to a device to device (D2D) mobility management method, a user equipment using the same method, and a network entity using the same method.

### BACKGROUND

D2D broadcast communications has been introduced in Long Term Evolution (LTE) Release-12 (Rel-12) and LTE Rel-13 as a promising technology to realize public safety and for commercial usage. LTE Rel-13 has also studied possibilities of cellular based vehicular network, such as by using D2D technique to support technologies related to ‘vehicles to everything’ (V2X). In such scenario, mobility management would be quite important. Also, a more sophisticated D2D mobility management method and system would need to be supported by wireless communication systems.

As D2D communication has been envisioned to satisfy a wide variety of services/applications, device topologies and the resource utilizations could be different according to properties of each scenario, service, or application. Thus, a smart D2D mobility management would need to consider not only the problems posed by the mobility itself but also the resource allocations due to device mobility. While the development of a 5G communication system is still at its initial stage, it has been envisioned that a 5G communication network would support network slicing and different air interface variants. Such proposal has been disclosed in “NGMN 5G White Paper, 2015” which is incorporated by reference for its definitions of terms and concepts. Thus, a 5G communication system would be expected to be flexible and scalable. Further, D2D communication would also be a significant feature to enhance the proximity-based services such as vehicle networks.

FIG. 1 illustrates an existing E-EUTRAN communication system which is capable of D2D wireless communication. However such architecture currently could be insufficient for optimal mobility management and flexibility of inter-Radio Access Technologies (RAT) scenarios. The communication system 100 of FIG. 1 has been introduced by Third Generation Partnership (3GPP) in Rel-12. The ProSe Function 101 is the logical function used by the network for implementing functions related to D2D communications as required by “3GPP TS23.303 Rel-13; “Proximity-based services (ProSe); Stage 2”, 2015” which is incorporated by reference for its concepts and definitions of terms. Thus far, there would only be one ProSe Function 101 in one Public Land Mobile Network (PLMN). In a ProSe Function 101, there would be three functions including Direct Provisioning Function (DPF), Direct Discovery Name Management Function, and EPC-level Discovery Function.

The DPF may provision a UE with PLMN specific parameters to allow the UE to use ProSe Direct Discovery and ProSe Direct Communication in the specific PLMN. For restricted ProSe Direct Discovery, the DPF may generate and maintain the ProSe Discovery UE ID. For Public Safety case in ProSe Direct Communication, the DPF may provide necessary parameters for a UE even though the UE is not served by E-UTRAN.

The Direct Discovery Name Management Function would be responsible for the mapping of ProSe Applications IDs and ProSe Application Codes. For each discovery request, the Direct Discovery Name Management Function would use subscriber data stored in a Home Subscriber Server (HSS) 102 for authorization. The Direct Discovery Name Management Function would provide security material to protect discovery messages. In the case of restricted ProSe Direct Discovery, the Direct Discovery Name Management Function would interact with the Application Server for the authorization of discovery request.

The EPC-level Discovery Function would store and retrieve subscriber data from the HSS 102 and is responsible for authorizations and configurations. The EPC-level Discovery Function would handle EPC ProSe User IDs and Application Layer User IDs. The EPC-level Discovery Function would exchanges signaling with ProSe Functions in other PLMNs and 3rd party application servers for application registration. The EPC-level Discovery Function would act as a location service agent such as a SLP 103. The SLP 103 is a location service protocol, allowing the device to find services in the local area network) to which the UE reports its location.

As a whole, the ProSe Function 101 would enable ProSe discovery and ProSe communications in the same PLMN as shown in FIG. 1 and between PLMNs as shown in FIG. 2. The communication architecture of FIG. 2 would support roaming between different PLMNs, and the principles of operation of FIG. 2 is described in 3GPP TR 23.303 which is incorporated by reference for its concepts and definitions. Although the 3GPP has implemented the D2D technology in E-UTRAN; however, the inter-RAT D2D implementation has not been significantly addressed. Furthermore, D2D mobility management from one RAT to another RAT has not been supported. Since the D2D communication has been anticipated, the industry wide applications and the catering of different air interface variants would likely be significant features for the 5G communications system. Thus a novel D2D mobility management functions and a D2D mobility management entity could be necessary for providing D2D-related information and for increasing the flexibility of D2D communication across different RATs.

### SUMMARY OF THE DISCLOSURE

Accordingly, the disclosure is directed to a device to device (D2D) mobility management method applicable to a network entity, a device to device (D2D) mobility management method applicable to a user equipment, a user equipment using the same method, and a network entity using the same method.

In one of the exemplary embodiments, the disclosure is directed to a device to device (D2D) mobility management method used by a network entity, and the method would include not limited to: transmitting a service request message which includes an application identifier (ID) and a traffic type ID; receiving a first measurement report comprising a signal quality measurement which is measured based on the service request message; determining a topology type ID and a communication type ID in response to receiving the first measurement report; transmitting an access request message which includes the topology type ID, the communication type ID, and the traffic type ID; and receiving an authorization of a network slice in response to transmitting the access request message.

In one of the exemplary embodiments, the disclosure is directed to device to device (D2D) mobility management method used by a user equipment, and the method would include not limited to: receiving a configuration as a relay UE to perform: receiving a service request message which comprises an application ID and a traffic type ID; transmitting a service announcement message which comprises a device ID of the relay UE and the traffic type ID; receiving a first remote UE measurement report performed based on the service announcement message, wherein the first remote UE measurement report includes a device ID and a hop count; and transmitting a relay UE measurement report which comprises a total hop count and the device ID of the relay UE.

In one of the exemplary embodiments, the disclosure is directed to a user equipment which would include not limited to: a transmitter; a receiver; and a processor coupled to the transceiver and is configured to: transmit, via the transmitter, a service request message which includes an application identifier (ID) and a traffic type ID; receive, via the receiver, a first measurement report comprising a signal quality measurement which is measured based on the service request message; determine a topology type ID and a communication type ID in response to receiving the first measurement report; transmit an access request message which includes the topology type ID, the communication type ID, and the traffic type ID; and receive an authorization of a network slice in response to transmitting the access request message.

In one of the exemplary embodiments, the disclosure is directed to a network entity which would include not limited to: a transmitter; a receiver; and a processor coupled to the transceiver and is configured to: receive, via the receiver, a service request message which includes an application ID and a traffic type ID; transmit, via the transmitter, a service announcement message which includes a device ID of the relay UE and the traffic type ID; receive, via the receiver, a first remote UE measurement report performed based on the service announcement message, wherein the first remote UE measurement report includes a device ID and a hop count, and a relay UE measurement report which includes a total hop count and the device ID of the relay UE.

In order to make the aforementioned features and advantages of the disclosure comprehensible, exemplary embodiments accompanied with figures are described in detail below. It is to be understood that both the foregoing general description and the following detailed description are exemplary, and are intended to provide further explanation of the disclosure as claimed.

It should be understood, however, that this summary may not contain all of the aspect and embodiments of the disclosure and is therefore not meant to be limiting or restrictive in any manner. Also the disclosure would include improvements and modifications which are obvious to one skilled in the art.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 illustrates an existing E-EUTRAN communication system which is capable of D2D wireless communication.

FIG. 2 illustrates an existing E-EUTRAN communication system which is capable of D2D wireless communication between different PLMNs as described in 3GPP TS23.303.

FIG. 3 illustrates a D2D mobility management architecture in accordance with one of the exemplary embodiments of the disclosure.

FIG. 4A illustrates a D2D mobility management network entity in accordance with one of the exemplary embodiments of the disclosure.

FIG. 4B illustrates a D2D mobility management method used by a network entity in accordance with one of the exemplary embodiments of the disclosure.

FIG. 4C illustrates a user equipment in accordance with one of the exemplary embodiments of the disclosure.

FIG. 4D illustrates a D2D mobility management method used by a user equipment in accordance with one of the exemplary embodiments of the disclosure.

FIG. 5A illustrates examples of topology types in accordance with one of the exemplary embodiments of the disclosure.

FIG. 5B illustrates examples of topology types which include a relay in accordance with one of the exemplary embodiments of the disclosure.

FIG. 6A illustrates an example of an algorithm for determining a topology type ID in accordance with one of the exemplary embodiments of the disclosure.

FIG. 6B illustrates a flow chart for determining a topology type ID in accordance with one of the exemplary embodiments of the disclosure.

FIG. 7A1˜FIG. 7D illustrates a topology type management process in accordance with one of the exemplary embodiments of the disclosure.

FIG. 8 illustrates various communication types in accordance with one of the exemplary embodiments of the disclosure.

FIG. 9 illustrates a ID retrieval process in accordance with one of the exemplary embodiments of the disclosure.

FIG. 10 illustrates a signal procedure for the D2D mobility management function in accordance with one of the exemplary embodiments of the disclosure.

FIG. 11 illustrates a signal procedure for dynamic network slice selection and configuration of D2D UEs in accordance with one of the exemplary embodiments of the disclosure.

FIG. 12A˜FIG. 12B illustrates a process of inter-RAT management in accordance with one of the exemplary embodiments of the disclosure.

FIG. 13 illustrates a handover procedure from a source gNB to a target gNB in accordance with one of the exemplary embodiments of the disclosure.

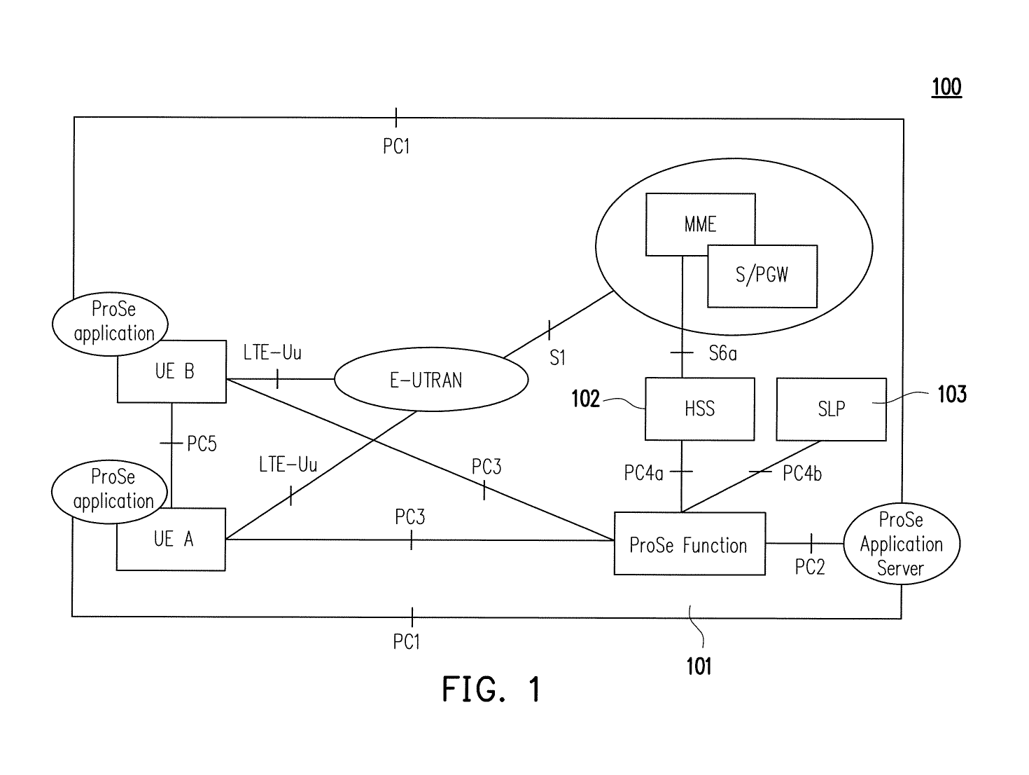

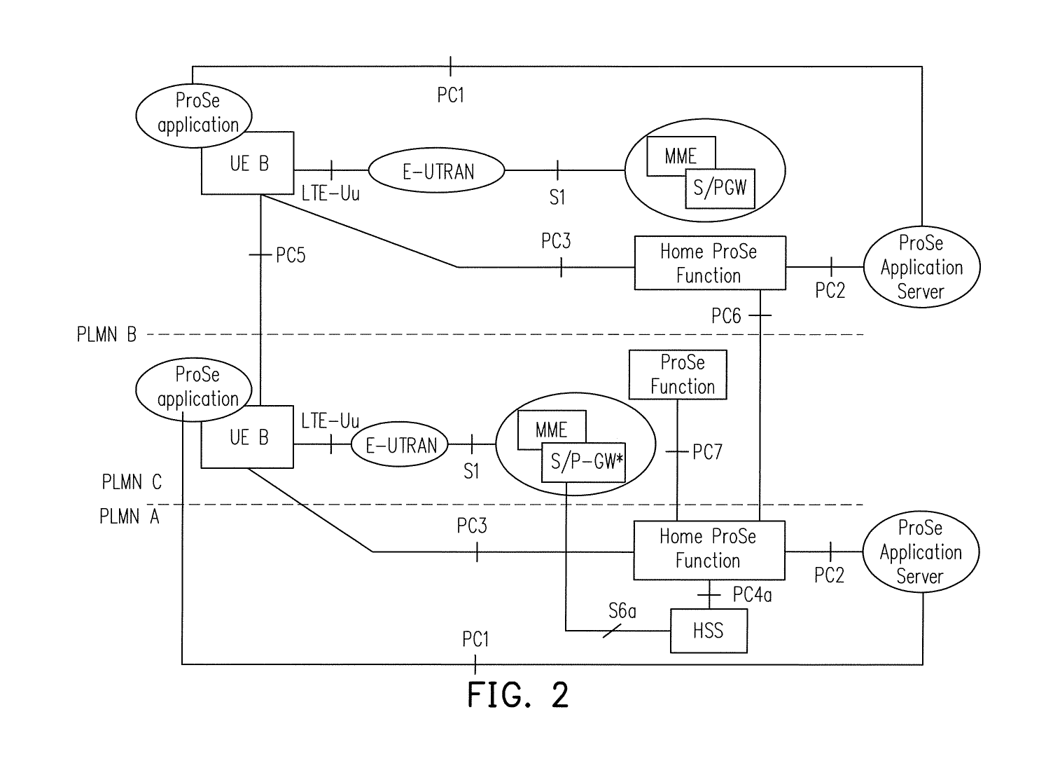

### DETAILED DESCRIPTION OF DISCLOSED EMBODIMENTS

Reference will now be made in detail to the present exemplary embodiments of the disclosure, examples of which are illustrated in the accompanying drawings. Wherever possible, the same reference numbers are used in the drawings and the description to refer to the same or like parts.

The disclosure provides a directed to a (smart) device to device (D2D) mobility management method and architectural apparatuses to implement the disclosed method. The disclosed method would utilize D2D mobility management functions to support smart D2D mobility management of user equipment (UEs) both within the same RAT and across different RATs. The D2D mobility management functions would include functions to realize (1) D2D topology type management, (2) D2D communications type management, and (3) D2D traffic type management. Such D2D mobility management functions could be performed either in the D2D mobility management entity or in the 5G radio access network (RAN).

In further detail, the (1) D2D topology type management would implement functions related to storing and maintaining D2D topologies such as pair, straight, capillary, and so forth. The (2) D2D communications type management would implement functions related to storing and maintaining D2D communications types such as unicast, broadcast, groupcast, and etc. The (3) D2D traffic management would implement functions related to recording and managing the D2D traffic requirements such as mission-critical, periodic, best effort, and etc. The D2D mobility management functions would also provide and maintain D2D-related information to assist mobility management and further resource management. This disclosure could be implemented for different air interface variants. With the provided disclosure, network slicing could also be realized.

First, examples of some 5G D2D or vehicle to vehicle (V2V) applications as well as the D2D mobility management functions that correspond to the applications are provided. For examples of 5G D2D applications may include not limited to platoon, autonomous vehicles, and wearable devices. The platoon may include the topology type of straight and pair, the communication type of group-cast, and traffic type of periodic and mission critical. The autonomous vehicle may include the topology type of dynamic, the communication type of broadcast, and traffic type of periodic and mission critical. The wearable devices may include the topology type of pair, the communication type of unicast, and traffic type of periodic. Further, each of the applications would have its own Application ID such that a gNB would also know the RAN level equivalent Application ID for each application. It is worth noting that, as seen from the examples above, each application may have different D2D topology type, D2D communications type, and D2D traffic type.

When it comes to D2D mobility management, not only handover but also resource allocation is very important to keep D2D service continuity, especially the D2D UE might move across RATs. Thus, it is required to have flexible architecture and functions to provide D2D mobility management. The advantages of the disclosure may include flexible design, compatibility with different RATs, and capability of network slicing. One of the aims of the disclosure is to cater to different air interface variants. As a whole, the proposed architecture and functions would support D2D mobility management, provide required D2D-related information to support D2D resource allocation and mobility management, and enable network slicing.

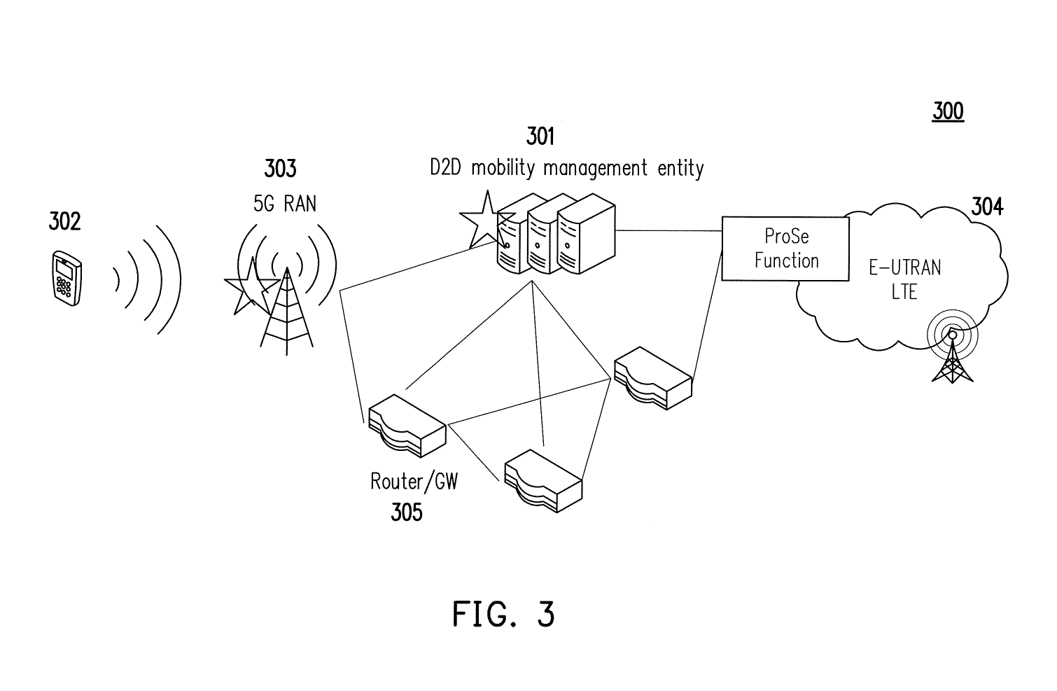

FIG. 3 illustrates a D2D mobility management architecture in accordance with one of the exemplary embodiments of the disclosure. The D2D mobility management architecture 300 may include a D2D mobility management entity 301 for implementing D2D mobility management functions. The D2D mobility entity 301 could be a part of any network entities within a core network or could be a part of a 5G base station (BS) situated within a RAN. D2D mobility management entity 301 would implement D2D-related information exchange, storage and maintenance. The D2D-related information would be used for D2D mobility management such as to manage different D2D topology types and timer, D2D communications types and D2D traffic types. The D2D mobility entity 301 may connect to any one of a 5G RAN (or BS) 303, E-TRAN, 304, routers or gateways 305, and so forth as well as other RATs.

For each D2D UE 302, specific D2D service IDs could be allocated according to D2D topology management, D2D communications type management, and D2D traffic management. The D2D service ID could be used to identify topology type of this UE, communications type of this UE, the traffic type of this UE, and also to update timer. For example, D2D service ID could be determined according to {D2D topology type+timer} +D2D communications type+D2D traffic type. Each D2D UE may have multiple D2D links, and each link may have a different topology type, a different communications type, and a different traffic types. Thus, a D2D UE may have one or more D2D service IDs.

Generally, D2D-related information would be kept and updated by the D2D mobility management entity 301. Each 5G RAN (e.g. 303) may request for the D2D-related information from the D2D mobility management entity 301. Since the D2D mobility management entity 301 would also connect to network routers and gateways 305 so that any updated D2D-related information including updated D2D-related information from other RATs can be retrieved immediately. The D2D mobility management entity 301 may either act as a proactive control node to notify other 5G RAN, E-UTRAN, gateways/routers and other radio access networks about the updated D2D-related information and assign the suitable traffic route or act as a passive node from which other 5G RAN, E-UTRAN, gateways/routers may request for the D2D-related information in order for the D2D-related information to be updated. Once a D2D UE moves across the network, inter-RAT handover is possible with the assistance of the D2D-related information in the D2D mobility management entity 301. The D2D mobility management entity 301 may also coordinate the required information exchange for inter-RAT D2D communications.

If a D2D mobility management entity (e.g. 301) does not exist in a network, then the 5G RAN (e.g. 303) could instead implement the storage and maintenance for the D2D-related information. A 5G RAN may then connect to other radio access networks either directly or indirectly via other routers/gateways so as to implement the above described D2D mobility management functions as well as to coordinate the inter-RAT D2D communications.

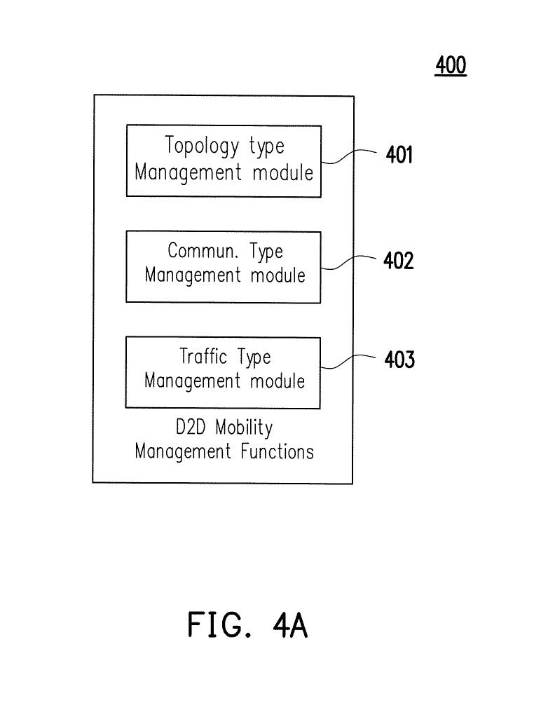

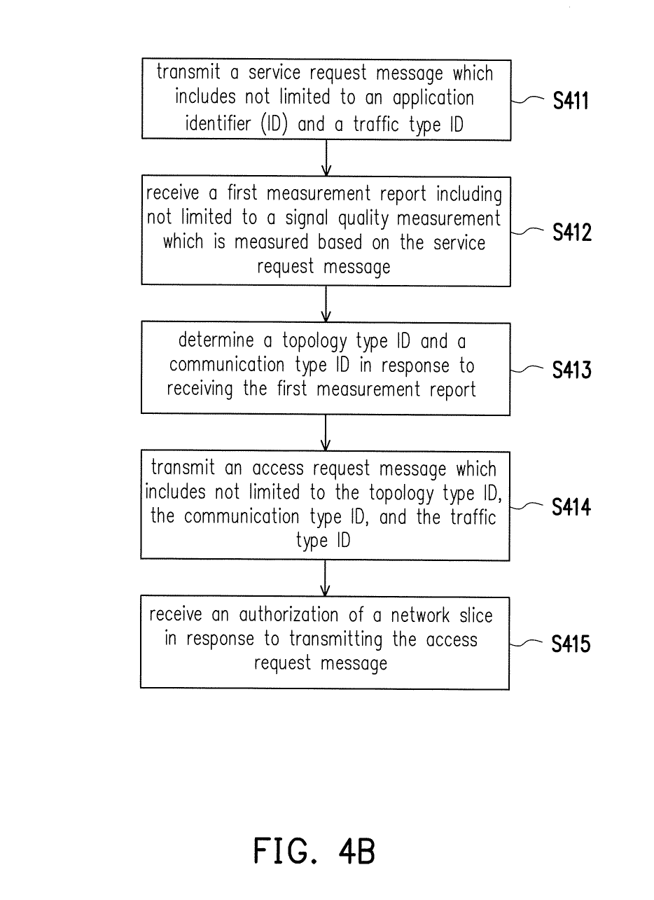

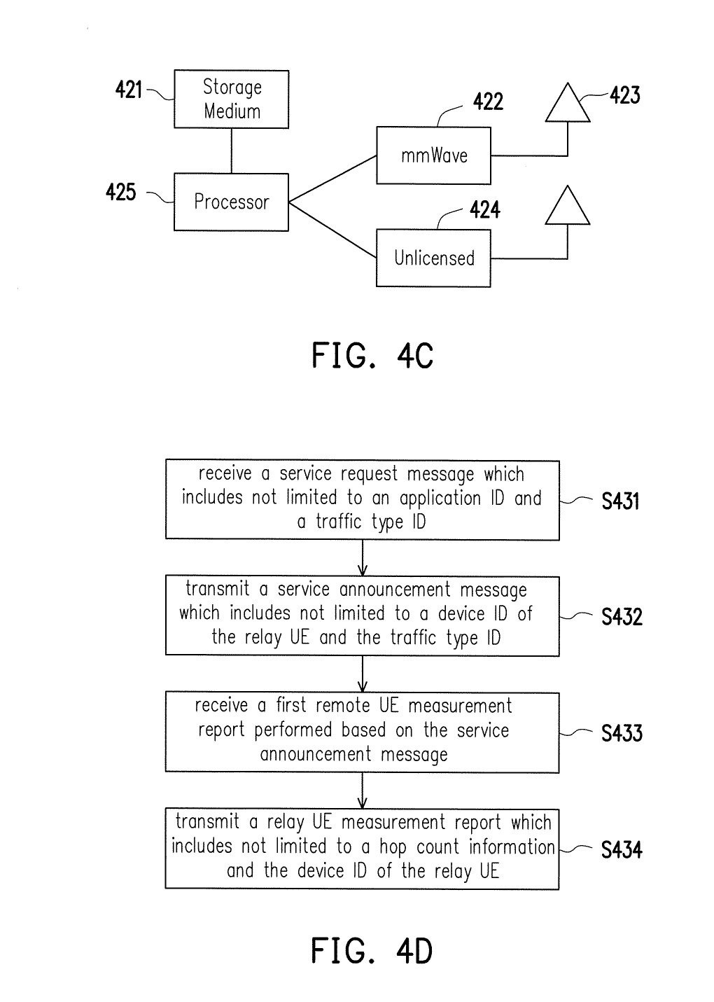

FIG. 4A illustrates a D2D mobility management entity in accordance with one of the exemplary embodiments of the disclosure. The D2D mobility management entity 400 may include not limited to a topology type management module 401 for managing not limited to topology types and related functions, a communication type management module 402 for managing not limited to communication types and related functions, a traffic type management module 403 for managing not limited to traffic types and related functions. The D2D mobility management entity 401 may include one or more processing circuits or processors for implementing the functions of the topology type management module 401, the communication type management module 402, and traffic type management module 403. These modules 401 402 403 could be implemented by one or more hardware processing units such as processors, controllers, or discrete integrated circuits. The D2D mobility management entity 401 may also include one or more hardware transceivers for communicating with the 5G RAN 303, with the routers or gateways 305, and with the E-UTRAN 304. The 5G RAN 303 would communicate with one or more D2D UEs 302. The D2D mobility management entity 400 would support dynamic network slice selection and configuration of D2D UEs.

FIG. 4B is a flow chart which illustrates a D2D mobility management method from the perspective of a network entity. In step S411, the network entity would transmit a service request message which includes not limited to an application identifier (ID) and a traffic type ID. In step S412, the network entity would receive a first measurement report including not limited to a signal quality measurement which is measured based on the service request message. In step S413, the network entity would determine a topology type ID and a communication type ID in response to receiving the first measurement report. In step S414, the network entity would transmit an access request message which includes not limited to the topology type ID, the communication type ID, and the traffic type ID. In step S415, the network entity would receive an authorization of a network slice in response to transmitting the access request message.

FIG. 4C is a functional block diagram of a UE in accordance with one of the exemplary embodiments of the disclosure. The UE may include not limited to a processor 421 coupled to a storage medium 425, an mmWave and/or radio frequency (RF) 422 transceiver, an unlicensed band transceiver 424, and an antenna array 423.

The storage medium 425 provides temporary storage or permanent storage to implement all related functions as needed. The transceiver 422 includes one or more transmitters and receivers operating in the mmWave frequency and/or RF frequency and is connected to the antenna array 423 to transmit signals. The unlicensed band transceiver 424 may include one or more transceivers for communicating in the unlicensed spectrum such as Wi-Fi, Bluetooth, NFC, and etc. The processor 421 may include one or more hardware processing units such as processors, controllers, or discrete integrated circuits to control the 422 transceiver to transmit and receive signals and to execute functions related to the disclosed D2D mobility management method as disclosed by the exemplary embodiments and examples.

The term “user equipment” (UE) in this disclosure may be, for example, a smart watch, a virtual reality apparatus (VR), a vehicle, an autonomous vehicle, a mobile station, an advanced mobile station (AMS), a server, a client, a desktop computer, a laptop computer, a network computer, a workstation, a personal digital assistant (PDA), a tablet personal computer (PC), a scanner, a telephone device, a pager, a camera, a television, a hand-held video game device, a musical device, a wireless sensor, and the like. In some applications, a UE may be a fixed computer device operating in a mobile environment, such as a bus, a train, an airplane, a boat, a car, and so forth.

FIG. 4D is a flow chart which illustrates a D2D mobility management method from the perspective of a user equipment. In step S431, the UE would receive a service request message which includes not limited to an application ID and a traffic type ID. In step S432, the UE would transmit a service announcement message which includes not limited to a device ID of the relay UE and the traffic type ID. In step S433, the UE would receive a first remote UE measurement report performed based on the service announcement message. In step S434, the UE would transmit a relay UE measurement report which includes not limited to a hop count information and the device ID of the relay UE.

When a D2D UE moves, the D2D link might become weak and may eventually be handed over in order to continue engaging in D2D communication. The D2D handover can be either within the same radio access network system or inter-RAT such as from 5G RAN to E-UTRAN. When a D2D UE performs D2D handover, specific information is required to assist with the connection or the configuration to setup the connection. The D2D mobility management entity 400 would aim to assist mobility management and further resource allocations. Each of the modules of D2D mobility management entity 400 would be further described herein.

The D2D mobility management entity 400 would include a topology management module 401 for managing D2D communication topology type. D2D communications may take places in certain locations such as in the bus, on the high way, in the road side unit and in the mall. The UE locations or connections may form a certain topology. This topology can be inferred by the D2D applications and D2D trace prediction. The topology can be static or can change dynamically, and the static or dynamic configuration of the topology may depend on factors including D2D UEs join or leaving a chain, the mobility velocity of D2D UEs, and etc so that the topology management module 401 may handle the dynamic topologies according to the services or mobility traces. Once the network receives the topology related information, the D2D communications can be better optimized and controlled.

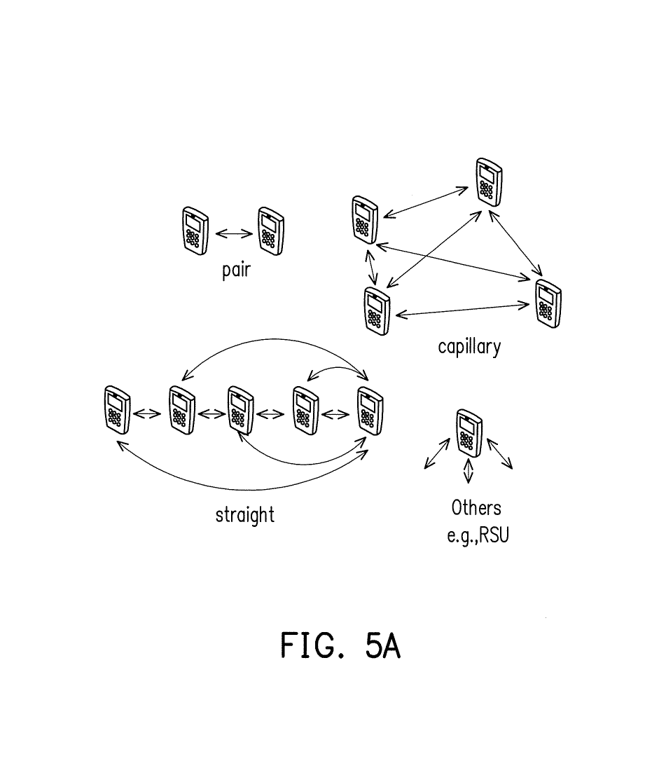

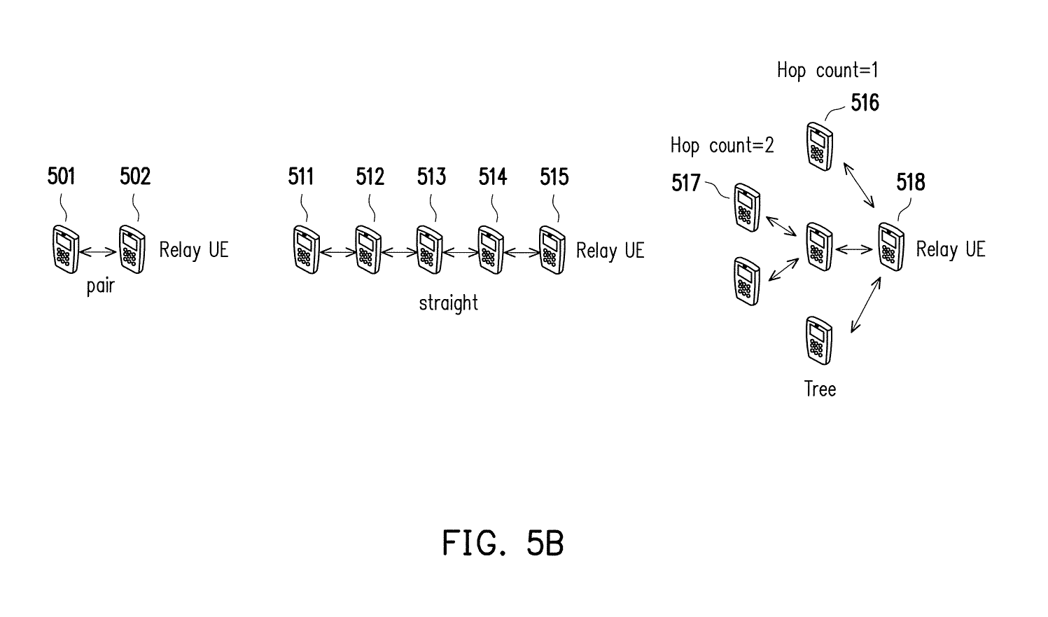

The topology management module 401 would use topology Type IDs to define which topology type this D2D UE belongs to. FIG. 5A shows some examples of D2D topology types including a pair, straight, capillary, circle, and others (e.g., road site unit). Each of the D2D topology types has a unique D2D UE ID. Each of the unique D2D UE ID could be associated with a UE ID and a timer such that each UE could be associated with a D2D topology type ID and hence the topology management module 401 would know the topology type of each UE that engages in D2D communication.

Moreover, in order to extend the range of the D2D communication, a relay UE could be utilized to communicate directly with a base station. FIG. 5B illustrates examples of using UE relays as each UE relay may directly connect to a base station.

For instance, referring to the ‘Pair’ topology of FIG. 5B, a first UE 501 would engage in D2D communication with the Relay UE 502 which would communicate with a base station in a 5G RAN. For ‘Straight’ topology of FIG. 5B, suppose that there are five UEs 511 512 513 514 515 within a group. Each of the UEs may communication with another UEs within the same group. For example, if a second UE 512 engages in D2D communication with the Relay UE 515, and their messages would be forwarded by other UEs 513 514 of the same chain. The Relay UE 515 may communicate with a base station and thus facilitate the D2D communication for the entire group on behalf of the base station.

Relay UE 515 and UE 518 would keep track of the hop count for each of the UEs within the same group and deliver such information to the topology management module 401 through a 5G base station. For example, referring to ‘Tree’ topology of FIG. 5B, the Relay UE 518 has a hop count of 0 since the Relay UE 518 communicates with a base station directly. Since the third UE 516 would require 1 hop to transmit a message to a base station through the Relay UE 518, the third UE 516 under this particular topology has a hop count of 1. The fourth UE 517 would require 2 hops to transmit a message to a base station and thus would have a hop count of 2.

For this disclosure in general, each remote UE within a group would need to have direct or indirect connection with a Relay UE. For FIG. 5B, remote UEs are UEs that are not the Relay UE (e.g. 502, 515, 518). For ‘Pair” topology, the number of remote UE is 1. For ‘Straight’ topology, the maximum hop count would equal the number of remote UEs. For ‘Tree’ topology, the maximum hop count would be less than the number of remote UEs.

It is worth noting that each group such as the D2D UE group that includes 511, 512, 513, 514, 515 may change its members. Also, each UE may have multiple links and may belong to different D2D groups. Suppose that UE 501 is the same as UE 511, then the UE 501/511 may have two links and belong to two different groups. Each link could be assigned with a link ID which is associated with a topology type ID and a timer. Thus, the topology management module 401 may maintain a table with each entry containing information such as {UE ID, topology type ID, timer}. Each entry of the table may also record information such as {link ID, topology type ID, timer}.

The topology timer would be used to define how often the topology is to be updated. For different topologies, timer duration associated with a topology type ID or a particular link ID could be different. As soon as the timer associated with a topology type ID has expired, the D2D topology would be updated. Similarly, as soon as the timer associated with a link ID has expired, the link would be reassessed.

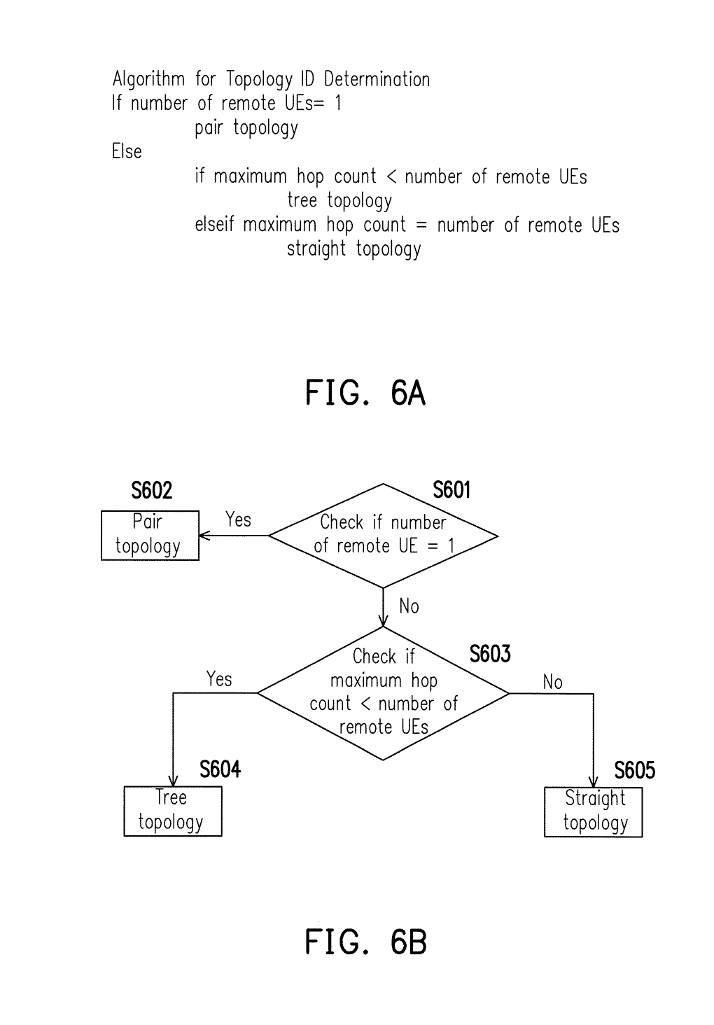

An example of an algorithm for determining a topology type ID is shown in FIG. 6A. The procedure for determining a topology type ID based on the algorithm of FIG. 6A is shown in FIG. 6B. It is assumed that a first ID is pre-assigned for ‘Pair’ topology, a second ID is pre-assigned for ‘Tree’ topology, and a third ID is pre-assigned for ‘Straight’ topology. The procedure for determining a topology type ID based on FIG. 6B is as follows. In step S601, the topology management module 401 would detennining if a number of remote UE is 1. If so, then in step S602, the topology would be determined as ‘Pair’, and thus the topology type ID would be the first ID. If not, then in step S603, the topology management module 401 would determine if the maximum hop count of a D2D UE group is less than the number of remote UEs. If yes, then in step S604, the topology would be determined as ‘Tree’, and thus the topology type ID would be the second ID. If no, then in step S605, the topology would be determined as ‘Straight’ topology, and thus the topology type ID would be the third ID.

Topology analysis can be implemented by the topology management module 401 or by a processor by the D2D mobility management entity 400 to analyze the mobility traces and locations to determine the topology type IDs. Topology analysis may also predict the topology according to the D2D mobility traces and locations. This topology analysis may take place in a D2D UE, a BS in the 5G RAN or a D2D mobility management. The three functions, the topology type ID analysis, the topology timer implementation, and the topology analysis, may not necessarily be located in the same entity. However, topology type ID analysis and topology timer implementation might be better suited in the same entity because a topology timer would normally be linked with the availability of the topology type ID. However, the topology analysis can be performed by any of a D2D UE, a BS in 5G RAN or a D2D mobility management entity. Topology type ID and topology timer could be stored in either a D2D mobility management entity or in a BS of a 5G RAN.

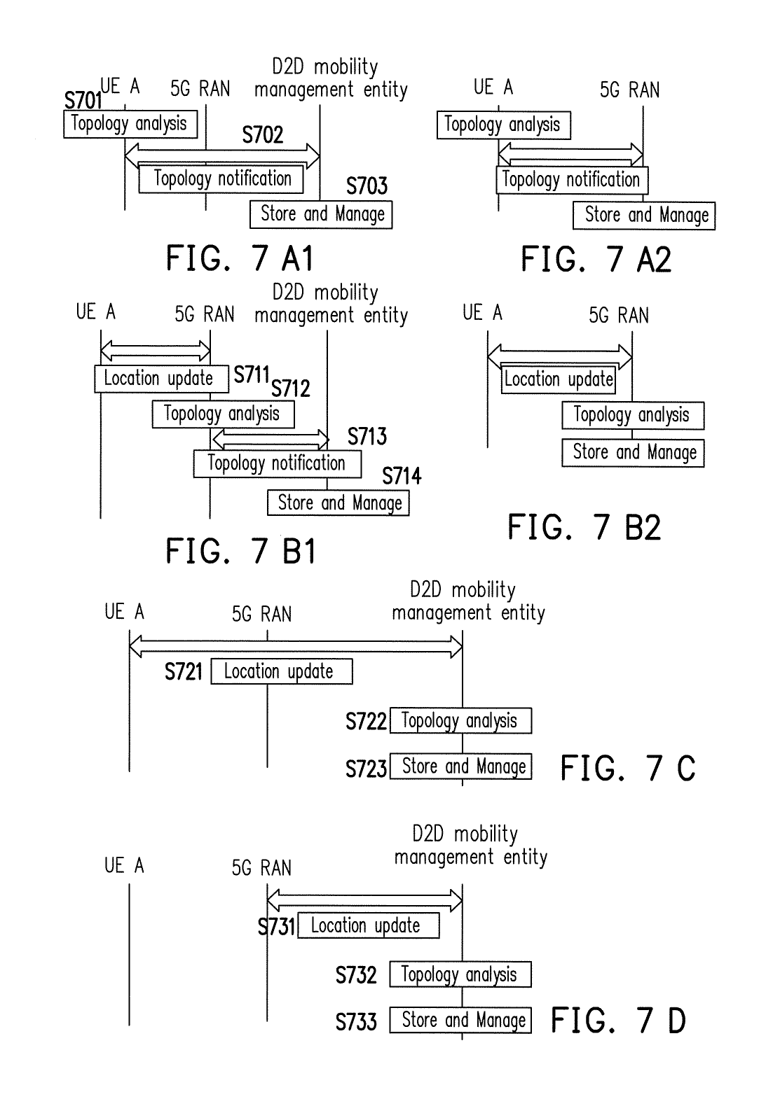

FIG. 7A1˜FIG. 7D illustrates a topology type management process in accordance with one of the exemplary embodiments of the disclosure. Referring to

FIG. 7A1, in step S701, a D2D UE would perform topology analysis to determine the current topology of a D2D UE group. The D2D UE would analyze its topology based on its locations and the location of others, or a prediction. In step S702, the D2D UE would inform a D2D mobility management entity 400 of the result of the topology analysis through a 5G RAN. In step S703, the D2D mobility management entity 400 would store and manage the result of the topology analysis. The exemplary embodiment of FIG. 7A2 is similar to FIG. 7A1 but the store and manage step is performed by the 5G RAN instead of the D2D mobility management entity 400.

For the exemplary embodiment of FIG. 7A1 in which step S703 is performed by a D2D mobility management entity 400, the D2D mobility management entity 400 would store and manage the topology type ID and topology timer. Alternatively, the topology analysis may also be performed by the 5G RAN and the D2D mobility management entity. For the exemplary embodiment of FIG. 7A2 in which step S703 is not performed by a D2D mobility management entity 400 but by the 5G RAN, the 5G

RAN would store and maintains the topology type ID and topology timer. A D2D mobility management entity does not necessarily have to exist in a network system. If a D2D mobility management entity exists, it would likely to retrieve topology type ID from the 5G RAN if needed.

For the exemplary embodiment of FIG. 7B1, in step S711, the D2D UE would determine its location and reports its location to the 5G RAN. In step S712, based on the location information received from one or more D2D UEs, the 5G RAN would determine the topology based on the collection of D2D UEs' locations and even predictions. In step S713, the 5G RAN would notify a D2D mobility management entity of the result of the topology analysis. In step S714, the D2D mobility management entity would store and manage the topology information.

The exemplary embodiment of FIG. 7B2 is similar to the exemplary embodiment of FIG. 7A1 but step S713 is performed within a D2D mobility management entity instead of the 5G RAN. In such case, 5G RAN stores and maintains the topology type ID and topology timer. The D2D mobility management entity does not necessarily have to exist in the network system. However, if the D2D mobility management entity exists in the network system, it is likely to retrieve topology type ID from the 5G RAN if needed. For the exemplary embodiment of FIG. 7C, in step S721, the D2D UE would perform a location update and transmit its location to the D2D mobility management entity through the 5G RAN. In step S722, the D2D mobility management entity would perform topology analysis based on locations of one or more UEs within a UE group and subsequently store and manage based on the results of the topology analysis. Steps S731, S732, S733 of the exemplary embodiment of FIG. 7D would be similar to steps S721, S722, and S723 of FIG. 7C except that the location update is performed by a 5G RAN instead of a D2D UE.

For any of the exemplary embodiments of FIG. 7A1˜FIG. 7D in general, if the topology timer times out, either the 5G RAN or the D2D mobility management entity, whichever is responsible for storage and maintenance, would send a request to whichever the entity (D2D UE, 5G RAN, or D2D mobility management entity) that is responsible for topology analysis, for updated topology. The entity (D2D UE, 5G RAN, or D2D mobility management entity) that is responsible for topology analysis, may also request the 5G RAN or D2D UE for location update. This approach is to passively request for location update and topology analysis. However, it is also possible that the D2D UE would proactively reports its location, and/or the entity responsible for topology analysis (D2D UE, 5G RAN, D2D mobility management entity) would proactively report the update the topology of any D2D UE group. Once the topology is updated, the topology timer would be reset.

The D2D mobility management entity 400 would include a communication type management module 402 for managing D2D communication type. D2D communications can be realized by various communications types. Some D2D UEs require unicast while some need broadcast communications. The communications types may vary according to different applications and scenarios. The communications types are also forced to change by the 5G RAN as a result of radio resource management. The communication type management module 402 may also record and manages the communications types of each D2D UE. If a D2D UE has several D2D links, each D2D link may have its own communication type. Once a network knows information with regard to communication types of each UE or each D2D link, D2D communications could be optimized and controlled.

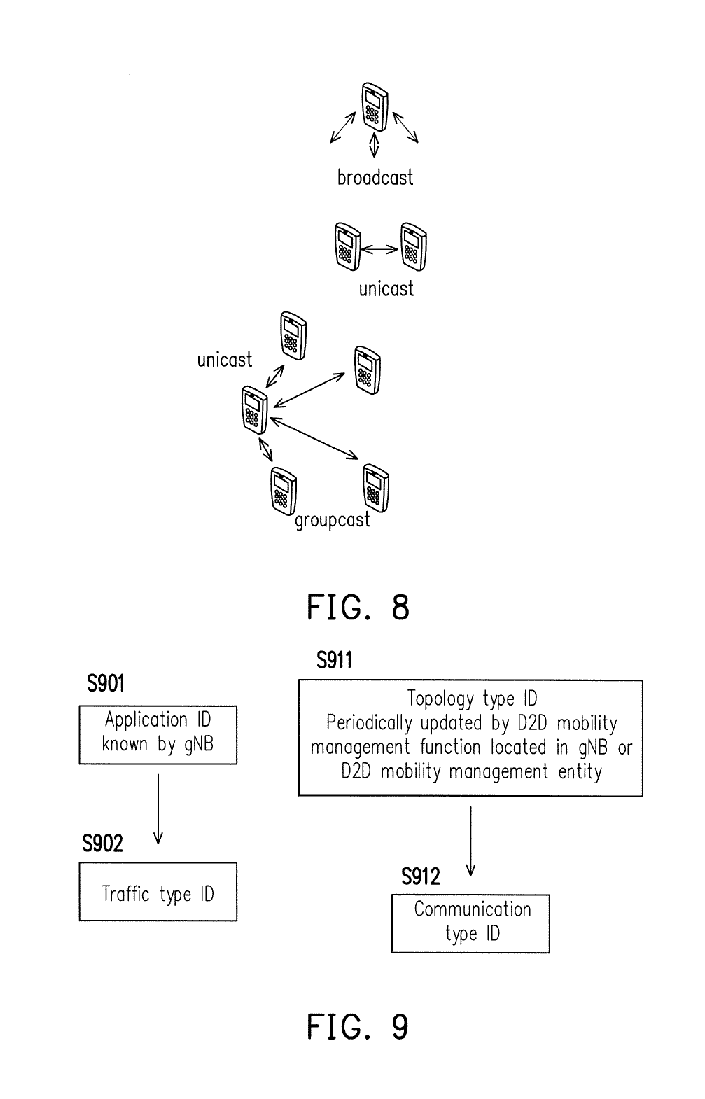

FIG. 8 illustrates various communication types which may include not limited to a ‘broadcast’ communication type, a ‘unicast’ communication type, a ‘groupcast’ communication type, and etc. Each of the communication types may have a unique communication type ID associated with a UE. Each communication type ID may further be associated with a link ID. Although a communication type of a D2D UE group might be preconfigured for the entire group, any expansion or contraction of the D2D UE group may cause the communication type to by dynamically changed. Since each D2D UE might have multiple D2D links to different D2D UEs, the D2D communication type can be tagged to a D2D link or a D2D UE. The required information can be one of at least {UE ID, communication type ID}, {D2D link ID, communication type ID}, and {UE ID, D2D link ID, communication type ID}.

The communication type could be determined by the communication type management module 402 or could be implemented by a processor within a base station or a D2D mobility management entity 400 to determine the communication type IDs. Alternatively, the communication type (ID) may also be determined a D2D UE itself or by 5G RAN. The 5G RAN may determine the most suitable communication type for D2D UEs based on the network load and resource usage. Any entity (D2D UE or 5G RAN) that determines the communication type would also implement the update or deletion of the communication type in the entity (5G RAN or D2D mobility management entity) that stores and manages the updated communication type. However, storage and maintenance of the communication type ID and the determination of communication may not necessarily be performed by the same entity.

If the storage and maintenance of communication type ID is by the D2D mobility management entity 400, the D2D mobility management entity 400 may store and manage the communication type ID and related information. However, the 5G RAN may determine the communication type for the D2D UEs and notify the determination to the D2D mobility management entity 400. Similarly, a D2D UE may determine the communication type and notify the determination to the 5G RAN and D2D mobility management entity.

If the storage and maintenance of communication type ID is by the 5G RAN, the 5G RAN would store and maintain the communication type ID and related information. A D2D mobility management entity (e.g. 400) does not necessarily have to appear in a network system. If a mobility D2D mobility management entity exists, it is likely to retrieve communication type ID from the 5G RAN if needed. Under such scenario, the 5G RAN would be responsible for updating the communication type and transmit the communication type to the D2D mobility management entity which would then store and maintain the communication types. Based on the communication type, the 5G RAN may further allocate resources to the D2D UEs.

The D2D mobility management entity 400 would include a traffic type management module 402 for managing D2D communication traffic type. D2D communications can be used for different scenarios, but each scenario may have its own service/traffic requirements. The traffic types may include, for example, ‘mission-critical’ traffic type, ‘periodic’ traffic type, ‘best-effort’ traffic type, and so forth, and each traffic type has a unique traffic type ID. For urgent scenarios such as alarm and healthcare, the traffic type can be ‘mission-critical’ for which the latency and reliability are the most important. For cases such as advertisements, the traffic type can be ‘periodic’. For some cases such as monitoring systems, the traffic type can be ‘best-effort’. Each traffic type has its own requirements such as priority, reservation, latency and throughput. Each D2D UE may have multiple D2D links and each D2D link may have its own traffic type. Once the network knows the information with regard to traffic types, D2D communications could be optimized and controlled. The mobility management and further resource management would be more flexible.

The basic traffic types are preconfigured, while any expansion (e.g., new traffic type) is allowed. Since each D2D UE might have multiple D2D links to different D2D UEs, the D2D traffic type can be tagged to a D2D link or a D2D UE. The required information can be at least {UE ID, traffic type ID}, {D2D link ID, traffic type ID} and {UE ID, D2D link ID, traffic type ID}.

The determination of traffic type could be made by a traffic type management module 403 or by a processor of the D2D mobility management entity 400 to determine the traffic type IDs. Traffic type determination can be accomplished by a UE itself or by a 5G RAN which may determine the optimal traffic type for each D2D UE group based on applications of the D2D UEs or their registrations. Any entity (D2D UE or 5G RAN) that determines the traffic type would be responsible for updating and deleting the traffic types in the entity (5G RAN or D2D mobility management entity) which stores and manages the updated traffic type.

The storing and managing of the traffic type IDs and traffic type determinations may not necessarily occur within the same entity. If the storage and maintenance of traffic type IDs is by the D2D mobility management entity 400, then the D2D mobility management entity 400 would store and manage the traffic type IDs and related information. If the traffic type determination occurs in the 5G RAN, then the 5G RAN would determine the traffic type for the D2D UE and notify the result of the determining to the D2D mobility management entity 400. A D2D UE may also determine the traffic type and notify to the 5G RAN and D2D mobility management entity the result for storage and future management. If the storage and maintenance of traffic type ID occur in the 5G RAN, the 5G RAN would store and maintain the traffic type ID and related information. The mobility D2D mobility management entity 400 does not necessarily have to exist in the network system. If a D2D mobility management entity exists, it is likely to retrieve traffic type ID from the 5G RAN if needed. Once the traffic type is known by the network, the 5G RAN or the network may further adjust the allocation of resources to the D2D UEs.

FIG. 9 illustrates an ID retrieval process in accordance with one of the exemplary embodiments of the disclosure. For this disclosure, the initial traffic type ID (S902) could be determined based on application ID (S901). The communicate type could be derived based on the topology of a D2D UE group and thus the communication type ID (S911) could be derived from a topology type ID (S912).

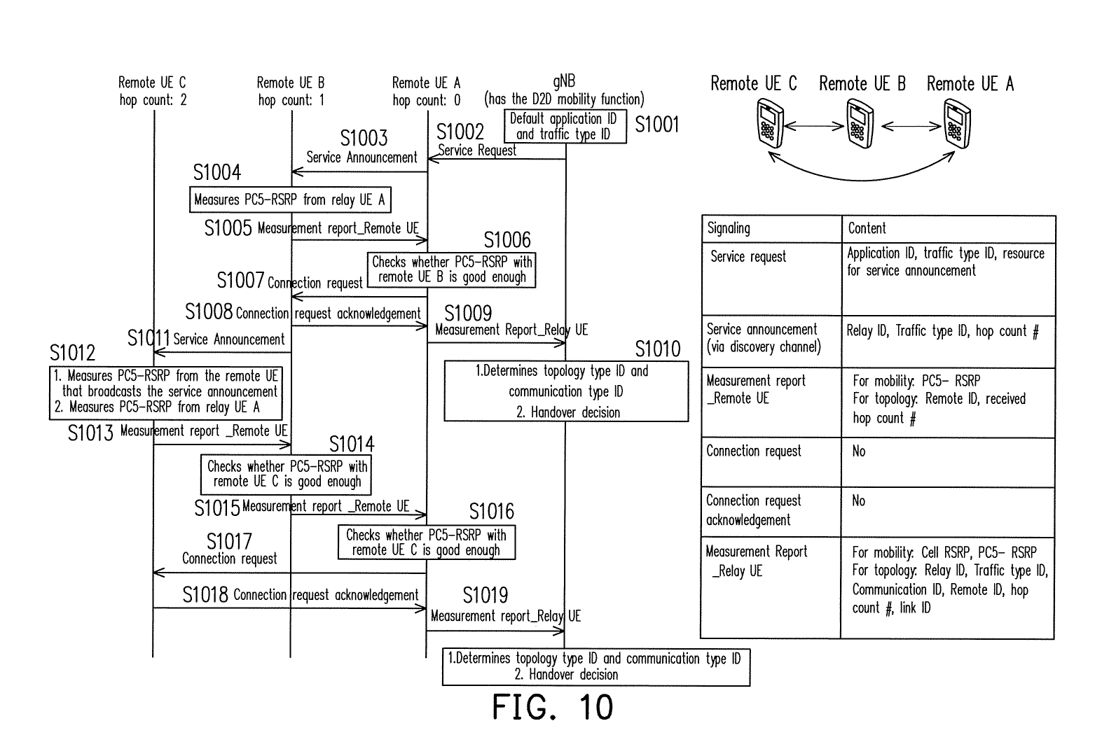

FIG. 10 illustrates a signal procedure for the D2D mobility management function in accordance with one of the exemplary embodiments of the disclosure. For this exemplary embodiment, it is assumed that the base station contains the D2D mobility management entity 400. However, D2D mobility management entity 400 could be independent from the base station, as a part of RAN, or as a part of the core network. It is also assumed that all D2D UEs in a group would be within a maximum transmission range of a Relay UE. Although the UE group in FIG. 10 includes a Relay UE, a Remote UE B, and a Remote UE C, it should obvious to one skilled in the art that the signalling procedure of FIG. 10 would extend to more than two remote D2D UEs. In general, a D2D UE would be authorized for service announcement after connection establishment. After the D2D UE receives the service announcement, the D2D UE would add the indicated hop count value by one and makes the new value its own hop count value. For example, a relay UE (e.g. Relay UE A of FIG. 10) has a hop count of zero, a second UE (e.g. D2D UE B of FIG. 10) which is immediate to the Relay UE A has a hop count of 1, and a third UE (e.g. D2D UE C of FIG. 10) which is immediate to D2D UE B has a hop count of 2, and so forth. The Relay UE may send a measurement report which includes the collected information of all other D2D UEs that are within the transmission information of the Relay UE and are within the same D2D group of the Relay UE to the base station. The base station subsequently updates the topology type ID and communication type ID based on the measurement report. The base station may then be able to make suitable handover decisions based on the measurement report. More specific details are described as follows.

In step S1001, the base station would configure one or more application IDs and traffic type IDs for UEs of a D2D group as each D2D UE may have an application ID and one or more traffic type IDs. In step S1001, the base station may transmit to a Relay UE A a Service Request message which may include not limited to an application ID, at least one a traffic type ID for each known UEs within the D2D group, and resources for service announcement. In step S1003, the Relay UE A may transmit to UE B a Service Announcement message which may include not limited to a device ID of the Relay UE A, at least one traffic type ID, and a hop count number of Relay UE A which would subsequently add one to the received hop count number. In step S1004, UE B would update the hop count number and measure PC5 reference signal received power(RSRP) from Relay UE A. In step S1005, UE B would transmit a measurement report which may include not limited to the measured PC5 RSRP of Relay UE A, a device ID of the UE B, and an updated hop count number of the UE B. The PC5 RSRP measurement is for making a mobility or handover related decision, and device IDs and the hop count number are for determining the topology of the D2D group. In step S1006 the Relay UE A would check whether the RCS RSRP in the received measurement report is sufficient. In step S1007, assuming that the RCS RSRP in the received measurement is sufficient, the Relay UE A would transmit a Connection Request message to UE B. In step S1008, the UE B would transmit a Connection Request Acknowledgment to Relay UE A. In step S1009, the Relay UE A would forward to the base station the RSRP measurement report received from UE B along with a cell RSRP measurement, ID of Relay UE A, at least one traffic type ID of UE B, at least one communication type ID of UE B, a device ID of UE B, and the hop count of UE B, and a link ID. In step S1010, the base station would be able to determine a (new) topology type ID and communication type ID for each UEs of the UE group in response to receiving the RSRP measurement report of Relay UE A.

In step S 1011, the UE B would transmit a Service Announcement message to UE C, and the Service Announcement message may include not limited to a device ID of Relay UE A, Traffic ID of UE B, and a hop count number of UE B. In step S1012, UE C would update its hop count and would perform PC5 RSRP measurement based on the Service Announcement message of UE B and also perform PC5 RSRP measurement based on the Service Announcement message of Relay UE A. In step S1013, the UE C would transmit to UE B a measurement report including not limited to the PC5 RSRP measurement result based on the Service Announcement message of UE B and also PC5 RSRP measurement result based on the Service Announcement message of Relay UE A along with the device ID of UE C and received hop count number. In step S1014, UE B would check whether the PC5 RSRP measurement result based on the Service

Announcement message of UE B and also PC5 RSRP measurement result based on the Service Announcement message of Relay UE A are sufficient. Assuming that the RSRP measurements are sufficient, in step S1015, UE B would transmit to Relay UE A a measurement report which would include not limited to the PC5 RSRP measurement result based on the Service Announcement message of UE B and also PC5 RSRP measurement result based on the Service Announcement message of Relay UE A along with their corresponding device IDs and received hop count number. In step S1016, the Relay UE A would determine whether the PC5 RSRP measurement result based on the Service Announcement message of UE B and also PC5 RSRP measurement result based on the Service Announcement message of Relay UE A are sufficient. In step S1017, the Relay UE A would transmit a Connection Request message to UE C. In step S1018, UE C would transmit to Relay UE A a Connection Request acknowledgement. In step S1019, the Relay UE A would forward to the base station the measurement report which would include the PC5 RSRP measurement result based on the Service Announcement message of UE B and also PC5 RSRP measurement result based on the Service Announcement message of Relay UE A along with cell RSRP experienced by UE C, device ID of Relay UE A, at least one traffic type ID of UE C, at least one communication type ID of UE C, hop count number of UE C, and a link ID.

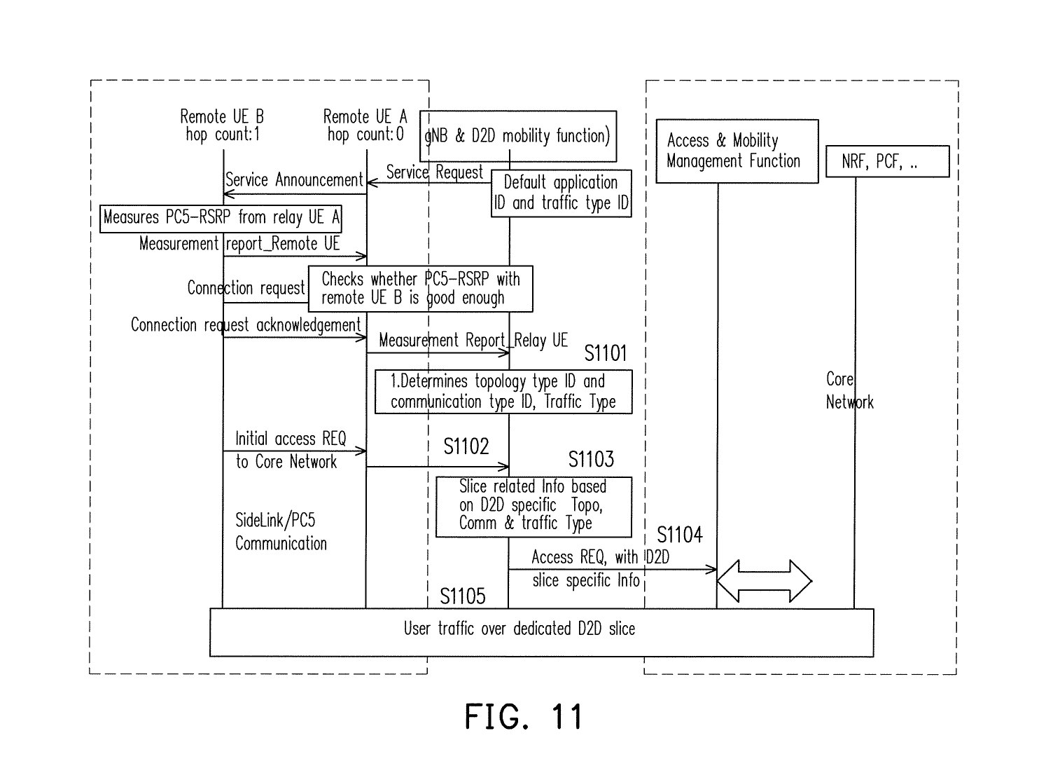

FIG. 11 illustrates a signal procedure for dynamic network slice selection and configuration of D2D UEs in accordance with one of the exemplary embodiments of the disclosure. For this exemplary embodiment, it is assumed that the base station contains the D2D mobility management entity 400. However, D2D mobility management entity 400 could be independent from the base station, as a part of RAN, or as a part of the core network. This exemplary embodiment is similar to the exemplary embodiment of FIG. 10, but the interaction among the base station, the core network, and D2D UEs are shown. Although the UE group in FIG. 11 includes a Relay UE, a Remote UE B, it should obvious to one skilled in the art that the signaling procedure of FIG. 11 would extend to more than one remote D2D UEs. The steps that precede step

S1101 are the same as steps S1001˜S1009.

In step S1101, the base station would be able to determine the at least one topology type ID (by configuring the topology type), the at least one communication type ID, and the at least one traffic type ID for each of the UEs in the known UE group in response to receiving a measurement report from the Relay UE A. In step S1102, the UE B would transmit an Initial Access Request message to the core network. In response to receiving the Initial Access Request message, in step S 1103, the base station would transmit network slice related information which may include not limited to topology type ID, communication type ID, and traffic type ID of each UE within a UE group. In step S 1104, the base station would transmit an Access Request message which may include not limited to the aforementioned slice related information. In step S 1105, the core network may grant a network slice based on the received slice related information, this particular D2D application, and traffic requirements. Subsequently, a D2D UE of a D2D group would be able to engage in D2D communication by using a particular slice assigned to the D2D UE.

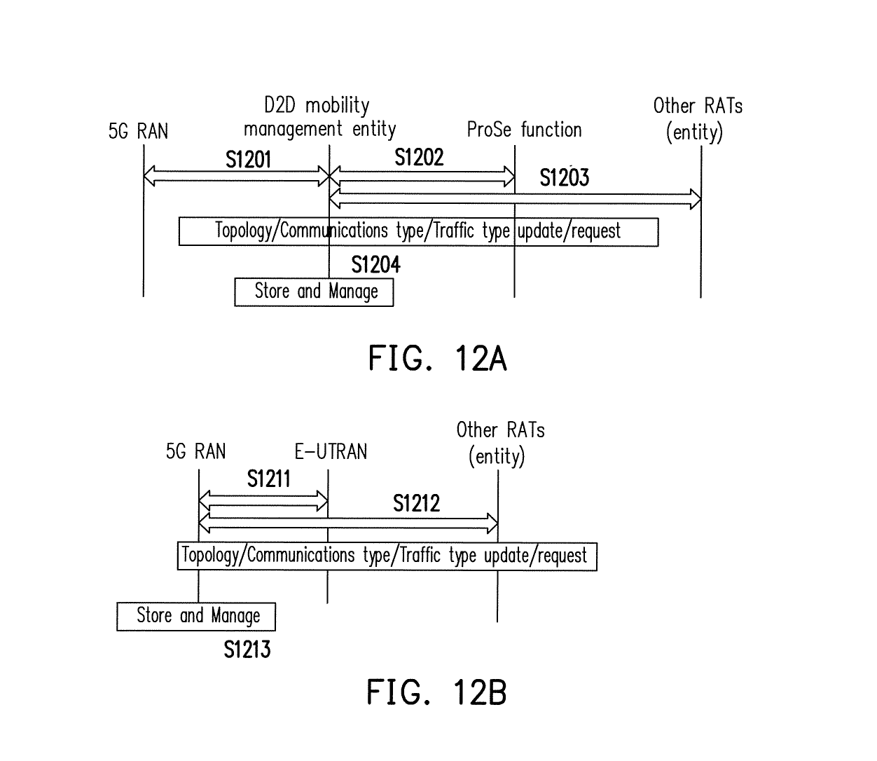

FIG. 12A˜FIG. 12B illustrates an inter-RAT management procedure in accordance with one of the exemplary embodiments of the disclosure. To satisfy D2D communication in the inter-RAT co-existence, mobility management is one of the important features. In the exemplary embodiment of FIG. 12A, the D2D mobility management entity (e.g. 400) may serve as a key role to store and maintain latest D2D communication information. The D2D mobility management entity may exchange D2D-related information to a RAT that also serves D2D communications. When an inter-RAT handover occurs, the D2D information maintained by D2D mobility management entity including not limited to topology type management (e.g. topology type IDs), communication type management (e.g. communication type IDs) and traffic type management (e.g. traffic type IDs) could be important for each RAT to prepare resources for D2D communication handover. With the D2D information, network slicing may also be enabled by considering the D2D information for proper network/resource slicing for specific D2D topology type, specific D2D communications type, or specific D2D traffic or service type.

The D2D information is mainly acquired by the signaling exchange between the D2D UEs and radio network such as 5G RAN. The 5G RAN then allocates radio resources for D2D communications, and thus the 5G RAN would need to update D2D information. A 5G RAN has the D2D context of D2D UEs which perform D2D communications under the 5G RAN, where ‘D2D context’ can be defined as the latest D2D information required by the 5G RAN to serve the ongoing D2D communications. Similar to the exemplary embodiment of FIG. 12A, for the exemplary embodiment of FIG. 12B, the 5G RAN may also store and manage D2D information such as topology type management information (e.g. topology type IDs), communication type management information (e.g. communication type IDs) and traffic type management information (e.g. traffic type IDs).

It is possible that 5G RAN may run at least one of the D2D mobility management functions so that the 5G RAN may compose the D2D information in 5G RAN and D2D information in D2D mobility management entity as the D2D context. The 5G RAN may maintain the D2D context of the ongoing D2D communications. Based on the D2D context, 5G RAN would be able to allocation resources for D2D communications. The D2D information in the D2D mobility management entity or the 5G RAN also assists inter-RAT D2D communications. The D2D mobility management entity within RATs keeps the updated D2D information so that each RAT can quickly retrieve the D2D information once the D2D UEs performs handover. No matter which RAT the D2D communications rely on, the RAT may be able to provide the required and customized resources for D2D UEs according D2D information.

An example of the above described inter-RAT management procedure is described as follows. Referring to FIG. 12A, the 5G RAN (S1201) may transmit D2D-related information to the D2D mobility management entity which keeps and maintains D2D information (S1204) in one or more storage medium. The ProSe Function (S1202) may transmit D2D-related information from E-UTRAN to the D2D mobility management entity which keeps and maintains D2D information (S1204). The D2D mobility management entity may exchange D2D information with other RATs such as topology type management information (e.g. topology type IDs), communication type management information (e.g. communication type IDs) and traffic type management information (e.g. traffic type IDs).

Referring to FIG. 12B, the 5G RAN (S1211) may receive D2D-related information from E-UTRAN in order to keep and maintains D2D information (S1213) in one or more storage medium. The 5G RAN (S1212) may exchange D2D information with other RATs such as topology type management information (e.g. topology type IDs), communication type management information (e.g. communication type IDs) and traffic type management information (e.g. traffic type IDs).

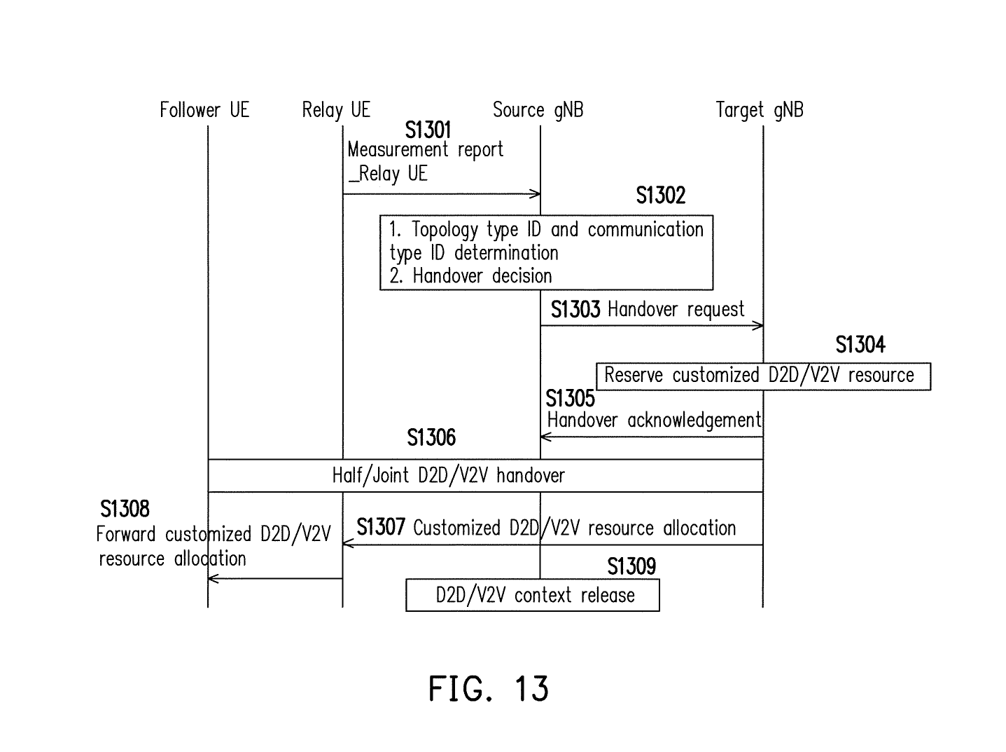

Next, a handover procedure from a source base station to a target base station is described. The handover procedure would involve not limited to a source base station, a target base station, a Relay UE, and a Follower UE as shown in FIG. 13. In step S1301, the source base station would receive a measurement report from the Relay UE. The content of the measurement report could be the same or similar to the measurement report described in step S1009. In step S1302, the source base station could determine the topology type ID, communication type ID, and whether to handover the Follower UE to the target base station based on the measurement report. Assuming that the Follower UE is to be handed over to the target base station, in step S1303, the source base station would transmit a handover request to the target base station. In step S1304, the target base station would reserve customized D2D or V2D resources in response to receiving the handover request. In step S1305, the target base station would transmit a handover acknowledgment to the source base station. In step S1306, the target base station would exchange signaling with the source base station as well as with the Follower UE through the Relay UE in order to receive the handover the Follower UE. In step S1307, the target base station would transmit customized D2D/V2V resource allocation which is destined toward the Follower UE to the Relay UE. In step S1308, the Relay UE would forward the D2D/V2V resource allocation to the Follower UE. In step S1309, the source base station would release the D2D/V2V context after the Follower UE has been handed over to the target base station.

In view of the aforementioned descriptions, the present disclosure is suitable for being used in a wireless communication system and is able to support D2D mobility management, to provide required D2D-related information in order to support D2D resource allocation and mobility management, and to enable future network slicing.

No element, act, or instruction used in the detailed description of disclosed embodiments of the present application should be construed as absolutely critical or essential to the present disclosure unless explicitly described as such. Also, as used herein, each of the indefinite articles “a” and “an” could include more than one item. If only one item is intended, the terms “a single” or similar languages would be used. Furthermore, the terms “any of” followed by a listing of a plurality of items and/or a plurality of categories of items, as used herein, are intended to include “any of”, “any combination of”, “any multiple of”, and/or “any combination of multiples of the items and/or the categories of items, individually or in conjunction with other items and/or other categories of items. Further, as used herein, the term “set” is intended to include any number of items, including zero. Further, as used herein, the term “number” is intended to include any number, including zero.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A device to device (D2D) communication management method used by a network entity, and the method comprising:
transmitting a service request message which comprises an application identifier (ID) and a traffic type ID;
receiving a first measurement report comprising a device ID of a relay user equipment (UE), a hop number, and a device ID of a remote UE
determining a topology type ID and a communication type ID in response to receiving the first measurement report;
transmitting an access request message which comprises the topology type ID, the communication type ID, and the traffic type ID; and
receiving an authorization of a network slice in response to transmitting the access request message.

2. The method of claim 1 further comprising:
performing a signal quality measurement which is measured based on the service request message; and
performing a handover decision based on at least the signal quality measurement.

3. The method of claim 1, wherein the traffic type ID is determined based on the application ID, and the communication type ID is determined based on the topology type ID.

4. The method of claim 1, further comprising:
receiving a second measurement report which comprises a hop number and a first device ID of a first remote UE; and
updating the topology type ID based on the second measurement report.

5. The method of claim 1, wherein determining the topology type ID comprises:
selecting from at least:
a first topology type ID which corresponds to a pair topology type;
a second topology type ID which corresponds to a straight topology type; and
a third topology type ID which corresponds to a tree topology type.

6. The method of claim 5, wherein
the pair topology type is selected in response to a quantity of remote UEs within a D2D group is only 1;
the straight topology type is selected in response to the quantity of the remote UEs within the D2D group is more than 1 but a maximum hop count of the remote UEs of the D2D group exceeds the quantity of the remote UEs; and
the tree topology type is selected in response to the quantity of the remote UEs within the D2D group is more than 1 but a maximum hop count of the remote UEs of the D2D group does not exceed the quantity of the remote UEs.

7. The method of claim 3, wherein the communication type ID is determined based on the topology type ID further comprising:
selecting the communication type ID from at least:
a first communication type ID which corresponds to a broadcast communication type;
a second communication type ID which corresponds to a unicast communication type; and
a third communication type ID which corresponds to a groupcast communication type.

8. The method of claim 3, wherein the traffic type ID is determined based on the application ID further comprising:
selecting the traffic type ID from at least:
a first traffic type ID which corresponds to a mission-critical traffic type;
a second traffic type ID which corresponds to a periodic traffic type; and
a third traffic type ID which corresponds to a best-effort traffic type.

9. The method of claim 2, wherein the handover decision is further based on at least the topology type ID, the communication type ID, and the traffic type ID.

10. The method of claim 1, wherein the topology type ID is associated with a timer which updates the topology type ID in response to an expiration of the timer.

11. The method of claim 6, further comprising:
updating the topology type ID based on the remote UEs moving in of the D2D group or moving out of the D2D group.

12. The method of claim 1, further comprising:
storing the topology type ID, the communication type ID, and the traffic type ID; and
transmitting the topology type ID, the communication type ID, or the traffic type ID to another radio access technology (RAT).

13. A device to device (D2D) communication management method used by a user equipment (UE), and the method comprising:
receiving a configuration as a relay UE to perform:
receiving a service request message which comprises an application identifier (ID) and a traffic type ID;
transmitting a service announcement message which comprises a device ID of the relay UE and the traffic type ID;
receiving a first remote UE measurement report performed based on the service announcement message, wherein the first remote UE measurement report comprises a device ID, and a hop count; and
transmitting a relay UE measurement report which comprises a hop count information and the device ID of the relay UE.

14. The method of claim 13 further comprising:
receiving a second remote UE measurement report performed based on the service announcement message wherein the second remote UE measurement report comprises a second hop count; and
performing a topology analysis based on the hop count and the second hop count,
wherein the relay UE measurement report further comprises a topology type information.

15. The method of claim 14, wherein first remote UE measurement report further comprises a signal quality measurement associated with the device ID, and the relay UE measurement report further comprises a second signal quality measurement performed based on the service announcement message, wherein the second signal quality measurement is associated with a second device ID, the method of claim 14 further comprising:
receiving a handover command in response to receiving a second remote UE measurement report.

16. The method of claim 13 further comprising:
receiving a configuration as a remote UE to perform:
receiving another service announcement message which comprises a received hop count, a device ID of another relay UE, and a traffic type ID;
performing another signal quality measurement based on the another service announcement message;
generating a current hop count by incrementing the received hop count by 1; and
transmitting another measurement report which comprises the current hop count and the another signal quality measurement.

17. The method of claim 13 further comprising:
transmitting a topology type ID, the communication type ID, and the traffic type ID and receiving an authorization to use a particular network slice.

18. The method of claim 16 further comprising:
receiving a handover command in response to transmitting the another measurement report.

19. A network entity comprising:
a transmitter;
a receiver; and
a processor coupled to the transceiver and is configured to:
transmit, via the transmitter, a service request message which comprises an application identifier (ID) and a traffic type ID;
receive, via the receiver, a first measurement report comprising a signal quality measurement which is measured based on the service request message;
determine a topology type ID and a communication type ID in response to receiving the first measurement report;
transmit an access request message which comprises the topology type ID, the communication type ID, and the traffic type ID; and
receive an authorization of a network slice in response to transmitting the access request message.

20. The network entity of claim 21, wherein the processor is further configured to:
perform a signal quality measurement which is measured based on the service request message; and
perform a handover decision based on at least the signal quality measurement.

21. A user equipment comprising:
a transmitter;
a receiver; and
a processor coupled to the transceiver and is configured to:
receive, via the receiver, a service request message which comprises an application ID and a traffic type ID;
transmit, via the transmitter, a service announcement message which comprises a device ID of the relay UE and the traffic type ID;
receive, via the receiver, a first remote UE measurement report performed based on the service announcement message, wherein the first remote UE measurement report comprises a device ID, and a hop count; and
transmit, via the transmitter, a relay UE measurement report which comprises a total hop count and the device ID of the relay UE.
